(19) United States
(12) Patent Application Publication
(10) Pub. No.: US 2008/0012277 A1
(43) Pub. Date: Jan. 17, 2008

(54) Air bag module with a filter screen

(75) Inventors: Eric R. McFarland, Gilbert, AZ (US); Jim Dunn, Kimball, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Vehicle Safety Systems Inc.

(21) Appl. No.: 11/484,086

(22) Filed: Jul. 11, 2006

(51) Int. Cl. B60R 21/26; B60R 21/217

(52) U.S. Cl. 280/736; 280/728.2; 280/740

(57) ABSTRACT

An apparatus (10) for helping to protect a vehicle occupant includes an inflatable vehicle occupant protection device (12) and an inflator (14) for providing inflation fluid to inflate the vehicle occupant protection device (12). The inflator (14) has a housing (15) having a side wall (27) and an end wall (24). The side wall (27) has inflation fluid exit ports (26) through which inflation fluid exits the inflator (14). An annular filter screen (70) is located outwardly from the housing and extends around the side wall (27). Inflation fluid exiting the inflator (14) flows through the annular filter screen (70) to cool the inflation fluid and filter hot combustion products from the inflation fluid. The filter screen has a central opening (74) defined by a circumferential edge (73) of the filter screen. The circumferential edge of the filter screen abuts or is in close proximity to the end wall.

### TECHNICAL FIELD

The present invention relates to an apparatus for helping to protect a vehicle occupant in a vehicle collision.

### BACKGROUND OF THE INVENTION

Many vehicles have an air bag that inflates to help protect a vehicle occupant when the vehicle is involved in a collision. The air bag is inflated by inflation fluid provided by an air bag inflator. Certain air bag inflators produce inflation fluid by combustion of a pyrotechnic material. Combustion products in the inflation fluid may be hot, and there are many known techniques for minimizing the possible contact of the combustion products with the material of the air bag.

Air bag retainers, which retain the air bag to an air bag module, are known to have deflectors to help direct hot inflation fluid away from the air bag. As an alternative, U.S. Pat. No. 6,336,659 shows an air bag module with a shield for protecting an air bag from hot inflation fluid.

### SUMMARY OF THE INVENTION

The present invention relates to an apparatus for helping to protect a vehicle occupant in a collision. The apparatus includes an inflatable vehicle occupant protection device and an inflator for providing inflation fluid to inflate the inflatable vehicle occupant protection device. The inflator has a housing having a side wall and an end wall. At least the side wall has inflation fluid exit ports through which inflation fluid exits the inflator. An annular filter screen is located outwardly from the housing and extends around the side wall. Inflation fluid exiting the inflator through the exit ports flows through the annular filter screen to cool the inflation fluid and filter hot combustion products from the inflation fluid. The annular filter screen has a central opening defined by a circumferential edge of the annular filter screen. The circumferential edge of the annular filter screen abuts or is in close proximity to the end wall of the inflator.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a sectional view of an apparatus constructed in accordance with the present invention; and

FIG. 2 is a top plan view of a portion of the apparatus of FIG. 1.

### DETAILED DESCRIPTION OF THE INVENTION

The present invention relates to an apparatus that includes an inflatable vehicle occupant protection device, such as an air bag. Other inflatable vehicle occupant protection devices that can be used in accordance with the invention include, for example, inflatable seat belts, inflatable knee bolsters, inflatable head liners, inflatable side curtains, and knee bolsters operated by inflatable air bags.

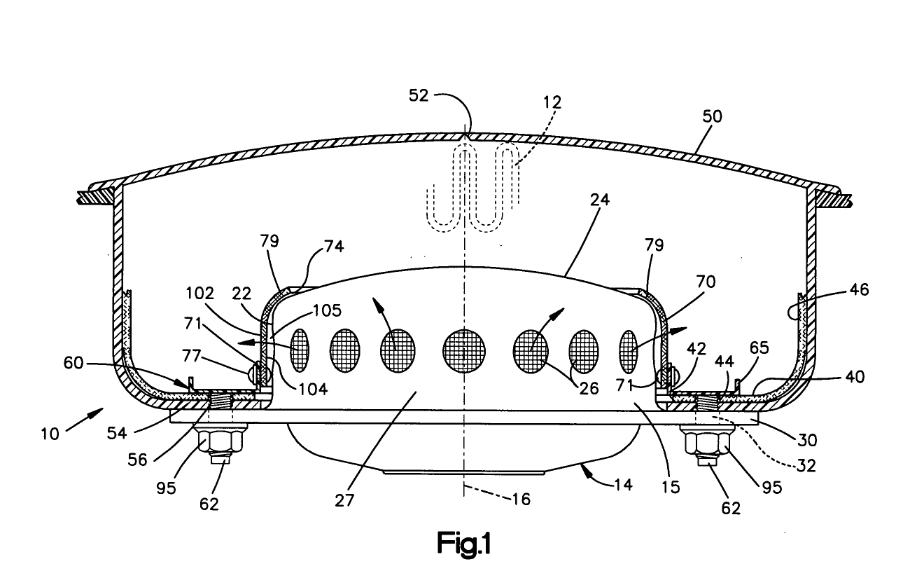

An apparatus 10 in accordance with the present invention is shown in FIG. 1. The apparatus 10 includes an air bag 12 and an inflator 14 to inflate the air bag 12. The inflator 14 contains an ignitable gas generating material, which, when ignited, produces a volume of inflation fluid in the form of a gas to inflate the air bag 12. Alternatively, the inflator 14 could contain a stored quantity of pressurized inflation fluid, or could contain a combination of pressurized inflation fluid and ignitable material for heating the pressurized inflation fluid.

The inflator 14 has a central axis 16 and includes a cylindrical housing 15. The housing 15 includes a circular upper end wall 24 and an axially extending cylindrical side wall 27. The upper end wall 24 of the housing 15 is domed, that is, has a curved configuration projecting upward (as viewed in the drawings) and inward from the side wall 27. A circumferentially spaced plurality of outlet openings 26 are formed in the side wall 27 of the housing 15 for directing inflation fluid out of the inflator 14 in directions extending transverse to the central axis 16.

An inflator mounting flange 30 projects radially outward with respect to the central axis 16 from a lower end (as viewed in FIG. 1) of the inflator 14. The inflator mounting flange 30 has four circumferentially spaced apart fastener openings 32. Lead wires (not shown) extend from the lower end of the inflator 14 and are electrically connected with electrical circuitry and with a vehicle collision sensor, such as a deceleration sensor or a contact sensor, for actuating the inflator, as known in the art.

The air bag 12 is made from a fabric material, such as woven nylon. The air bag 12 includes a mouth portion 40, which includes a central opening 42 through which the housing 15 of the inflator 14 extends. Four circumferentially spaced openings 44 are provided in the mouth portion 40 of the air bag 12 and are aligned with the fastener openings 32 of the mounting flange 30. Parts of the main body portion 46 of the air bag 12 are omitted for clarity in FIG. 1.

The apparatus 10 also includes a cover 50, which covers the folded air bag 12 and the inflator 14. The cover 50 has a rupturable tear seam 52, which is preferably not visible in the vehicle when the apparatus 10 is mounted in the vehicle. The cover 50 also has a mounting portion 54, which extends radially inward toward the axis 16 at a location between the air bag mouth portion 40 and the inflator mounting flange 30. The mounting portion 54 includes four circumferentially spaced fastener apertures 56.

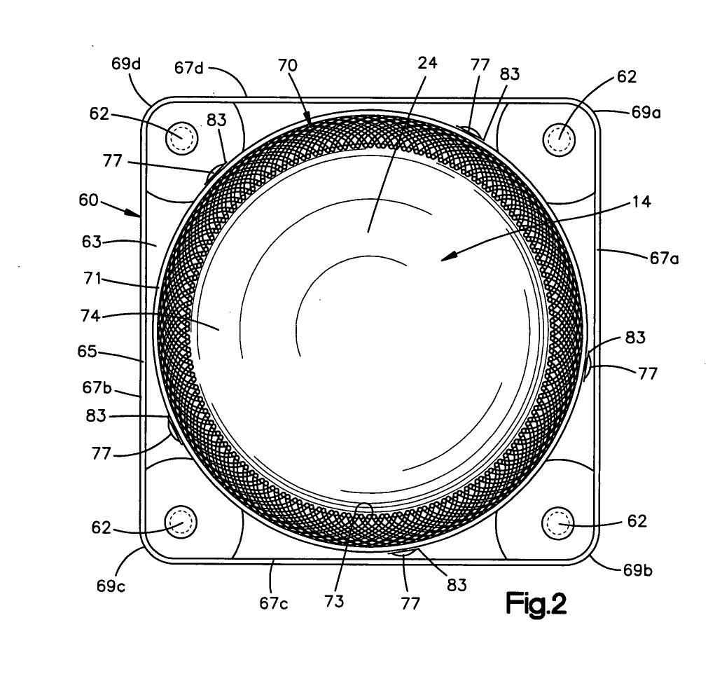

The apparatus 10 further includes a bag retaining ring 60. The retaining ring comprises a base 63. The retaining ring 60 includes a peripheral lip 65 extending upwardly from the outer edge of the base 63. The lip comprises right, left, front, and rear sides 67a-d and four rounded corners 69a-d as viewed in FIG. 2. The right side 67a and the left sides 67b of the lip 65 are straight and positioned parallel to each other. The front side 67c and the rear side 67d of the lip 65 are also positioned parallel to each other.

The bag retaining ring 60 further comprises an inner circular mounting flange 71 that extends upwardly from the inner edge of the base 63. The mounting flange 71 of the bag retaining ring 60 defines a central circular opening. The base 63, lip 65, and mounting flange 71 of the bag retaining ring 60 are injection molded to each other in one piece. The retaining ring 60 is made of plastic, but can also be made of metal or any other suitable material. Four steel mounting studs 62 are insert-molded on the base 63 of the plastic retaining ring 60.

The apparatus 10 further includes an annular filter screen 70 located outwardly from the housing 15. The filter screen 70 includes a wall portion 102 that is interposed between the side wall 27 of the inflator 14 and the air bag 12 and against which fluid exiting from the outlets 26 of the inflator 14 initially impinges. The filter screen 70 has an upper end 79 that extends inwardly from the wall portion 102, terminating in a circumferential edge 73 that is slightly spaced from the housing 15 and in close proximity to the intersection of the side wall 27 and upper end wall 24 of the housing 15. “Close proximity” means that the spacing between the housing 15 and the circumferential edge 73 is such that less than about 3% of the inflation fluid passes through the spacing. Alternatively, the circumferential edge 73 of the upper end 79 of the filter screen 70 could abut the housing 15 near the intersection of the side wall 27 and the upper end wall 24. The filter screen 70 has a central opening 74 defined by the circumferential edge 73 of the upper end 79 of the filter screen 70. As shown in FIG. 1, the central opening 74 has a diameter that is smaller than the diameter of the upper end wall 24. Alternatively, the diameter of the central opening 74 could be larger than the diameter of the upper end wall 24.

The filter screen 70 cools the inflation fluid and filters hot combustion products, such as hot particles, from the inflation fluid. Thus, the filter screen 70 helps to prevent contact between the air bag and hot combustion products in the inflation fluid exiting the inflator 14. As best seen in FIG. 2, the filter screen 70 comprises a metal screen. The metal screen may be in the form of woven wire, knitted wire, expandable metal, or a perforated sheet. The individual strands or sections of the metal screen are approximately 0.25 to 1.0 mm thick at their thinnest section. The openings in the metal screen may have any desired size or area.

As seen in FIGS. 1 and 2, the filter screen 70 is fastened to the mounting flange 71 of the bag retaining ring 60. In particular, rivets 77 are inserted through respective washers 83 and lateral openings of the mounting flange 71 and filter screen 70 to secure the filter screen 70 to the bag retaining ring 60.

During assembly of the apparatus 10, the filter screen 70 and retaining ring 60 are secured together as a unit as seen in FIG. 2. The bag retaining ring 60 and filter screen 70 circumscribe the inflator 14, when the inflator 14 and bag retaining ring 60 with filter screen 70 are installed. The studs 62 projecting from the retaining ring 60 extend through the openings 44 of the mouth portion 40 of the air bag 12, the respective apertures 56 in the mounting portion 54 of the cover 50, and fastener openings 32 in the mounting flange 30 of the inflator 14. Nuts 95 screwed onto the studs 62 clamp the mouth portion 40 of the air bag 12 between the retaining ring 60 and inflator mounting flange 30 and secure the filter screen 70, the inflator 14, and the air bag 12 in the apparatus 10.

The housing 15 of the inflator extends through the mounting portion 54 of the cover 50 and through the central opening 42 in the mouth portion 40 of the air bag 12. The central axis 16 of the inflator 14 extends through the central opening 74. The upper end wall 24 of the housing 15 projects through the central opening 74 of the filter screen 70.

The wall portion 102 of the filter screen 70 extends over the side wall 27 of the inflator 14 and covers the inflation outlets 26. The wall portion 102 is spaced outwardly from the inflator 14 to define a chamber 105 between an inner surface 104 of the wall portion 102 and outer side surface 22 of the housing 15 of the inflator 14 as shown in FIG. 1. The chamber 105 allows the inflation fluid to diffuse and distribute before the fluid passes through the filter screen 70. Because of this configuration of the inflator 14 and filter screen 70, the inflation fluid from the inflator 14 enters the chamber 105 at a faster flow rate than the fluid exits the chamber 105.

The vehicle in which the apparatus 10 is mounted includes known electrical means (not shown) for sensing an impact to the vehicle and for actuating the inflator 14 in response to the sensing of an impact. The electrical means may, for example, include a crash sensor, such as a deceleration sensor, and vehicle circuitry for electrically actuating the inflator 14 in response to a sensed vehicle condition for which inflation of the air bag 12 is desired to help protect the vehicle occupant. The electrical means is electrically connected with the inflator 14 for providing an actuation signal to the inflator 14.

In operation, when the inflator 14 is actuated, inflation fluid, as indicated by the arrows in FIG. 1, flows out of the inflator 14 through the inflation fluid outlets 26 in the outer side surface 22 of the housing 15 of the inflator 14. The inflation fluid flow from the inflator 14 is transverse to the central axis 16 of the inflator. The inflation fluid flows into the chamber 105 and then impinges on the inner surface 104 of the wall portion 102 of the filter screen 70, which filters out particles in the inflation fluid. The wall portion 102 directs a small amount of inflation fluid to flow into the air bag 12 through any small portion of the central opening 74 between the upper end 79 of the filter screen 70 and the inflator housing 15. The remaining inflation fluid flows through the filter screen 70. The filtering effect of the metal screen in the filter screen 70 reduces the flow rate of the fluid and thereby provides more time to allow the fluid to cool before the fluid strikes the air bag 12. As a result, hot particles that may be present in the flow of inflation fluid from the inflator 14 tend to contact the filter screen 70 instead of the air bag 12.

From the above description of the invention, those skilled in the art will perceive improvements, changes and modifications. Such improvements, changes and modifications within the skill of the art are intended to be covered by the appended claims.

For example, other suitable ways to fasten the filter screen 70 to the retaining ring could be used, such as screw fasteners. Alternatively, if the bag retaining ring is made of metal material, the filter screen could be secured by spot welding or crimping.

Having described the invention, the following is claimed:

1. An apparatus for helping to protect a vehicle occupant in a vehicle collision, said apparatus comprising:
an inflatable vehicle occupant protection device;
an inflator for providing inflation fluid to inflate said inflatable vehicle occupant protection device, said inflator having a housing, said housing having a side wall and an end wall, at least said side wall having inflation fluid exit ports through which inflation fluid exits said inflator; and
an annular filter screen located outwardly from said housing and extending around said side wall, inflation fluid exiting said inflator through said exit ports flowing through the annular filter screen to cool the inflation fluid and filter hot combustion products from the inflation fluid, said annular filter screen having a central opening defined by a circumferential edge of the annular filter screen, wherein said circumferential edge of said annular filter screen abuts or is in close proximity to said end wall of said inflator.

2. An apparatus as defined in claim 1 including a retainer secured to said inflatable vehicle occupant protection device and said inflator for retaining said inflatable vehicle occupant protection device to said inflator.

3. An apparatus as defined in claim 2, wherein said retainer includes a mounting flange surrounding said inflator, said annular filter screen being secured to said mounting flange.

4. An apparatus as defined in claim 3, wherein said filter screen is secured to said mounting flange by at least one rivet.

5. An apparatus as defined in claim 1 wherein said annular filter screen is a metal screen, said metal screen being formed of one of woven wire, knitted wire, expandable metal, and a perforated sheet.
